(19) United States
(12) Patent Application Publication
(10) Pub. No.: US 2015/0085486 A1
(43) Pub. Date: Mar. 26, 2015

(54) Lamp Device and Luminaire

(71) Applicant: Toshiba Lighting & Technology Corporation, Yokosuka-shi (JP)

(72) Inventors: Masazumi Ishida, Yokosuka-shi (JP); Junichi Kimiya, Yokosuka-shi (JP); Makoto Otsuka, Tokyo (JP)

(73) Assignee: TOSHIBA LIGHTING & TECHNOLOGY CORPORATION, Yokosuka-shi (JP)

(21) Appl. No.: 14/206,285

(22) Filed: Mar. 12, 2014

(30) Foreign Application Priority Data
Sep. 20, 2013 (JP) 2013-195744

(51) Int. Cl. F21V 15/01

(52) U.S. Cl. CPC F21V 15/011
USPC 362/249.01; 362/373; 362/294

(57) ABSTRACT

According to one embodiment, a thermal radiator of a lamp device includes a light-emitting module connection part to which a light-emitting module is thermally conductively connected. An attachment base is arranged around the light-emitting module connection part. The attachment base is made of an insulating material, and supports the light-emitting module connected to the light-emitting module connection part. The light-emitting module connection part protrudes from the attachment base.

### INCORPORATION BY REFERENCE

The present invention claims priority under 35 U.S.C. §119 to Japanese Patent Application No. 2013-195744 filed on Sep. 20, 2013. The content of the application is incorporated herein by reference in their entirety.

### FIELD

Embodiments described herein relate generally to a lamp device in which heat generated by a light-emitting module is radiated to the outside, and a luminaire using the lamp device.

### BACKGROUND

Hitherto, a flat lamp device such as, for example, a lamp device using a GH76p cap is proposed. In this lamp device, a light-emitting module and a lighting device are arranged in a housing provided with an opening part at one end side, and a thermal radiation member is attached to the other end side of the housing. The light-emitting module is thermally connected to the thermal radiation member. Heat generated by the light-emitting module is conducted to the thermal radiation member, and is conducted and radiated from the thermal radiation member to a luminaire side.

Besides, there is a lamp device in which a light-emitting module is arranged to be close to an opening part side of a housing in order to improve the light extraction efficiency of the lamp device. In this lamp device, the light-emitting module is distant from a thermal radiation member. Thus, a metal support member separate from the thermal radiation member is used, the light-emitting module is connected to and supported at one end side of the support member, and the other end side of the support member is connected and attached to the thermal radiation member. As a result, a heat conduction path from the light-emitting module to the thermal radiation member is secured. An attachment portion for attaching the light-emitting module is integrally protruded from the periphery at the one end side of the support member.

However, when the attachment portion for attaching the light-emitting module is integrally protruded from the periphery at the one end side of the metal support member, the distance between the attachment portion and a lighting device becomes short, and there occurs a problem in securing insulation properties. Besides, if an insulator is used for the attachment of the light-emitting module in order to solve the problem of securing the insulation properties, there is a fear that thermal radiation properties from the light-emitting module deteriorate.

### BRIEF DESCRIPTION OF THE DRAWINGS

FIG. 1 is a sectional view of a lamp device of an embodiment.

FIG. 2 is a sectional view of a part of the lamp device.

FIG. 3 is a perspective view of a decomposed state of the lamp device.

FIG. 4 is a perspective view of the lamp device.

FIG. 5 is a perspective view of the lamp device.

FIG. 6 is a sectional view of a luminaire using the lamp device.

### DETAILED DESCRIPTION

In general, according to one embodiment, a lamp device includes a housing, a light-emitting module, a lighting device, a thermal radiator and an attachment base. The housing includes an opening part at one end side, a closing part at the other end side and an insertion part formed at a center of the closing part. The light-emitting module is arranged in the housing to emit light from the opening part. The lighting device is arranged to be closer to the closing part side than the light-emitting module in the housing, and includes a circuit board arranged around the insertion part. The thermal radiator includes a support part inserted through the insertion part, a light-emitting module connection part which is provided at one end side of the support part and to which the light-emitting module is thermally conductively connected, and an external thermal radiation part provided at the other end side of the support part. The attachment base is made of an insulating material and is arranged around the light-emitting module connection part. An attachment surface facing the light-emitting module is provided at one end side of the attachment base, and the light-emitting module connection part protrudes from the attachment surface. The attachment base supports the light-emitting module connected to the light-emitting module connection part, and is thermally connected thereto.

As stated above, the insulating attachment base is arranged around the light-emitting module connection part of the thermal radiator. Thus, the light-emitting module can be attached, and insulation properties against the lighting device can be secured. Further, since the light-emitting module connection part protrudes from the attachment base, the light-emitting module certainly contacts the light-emitting module connection part, and excellent thermal radiation properties can be secured.

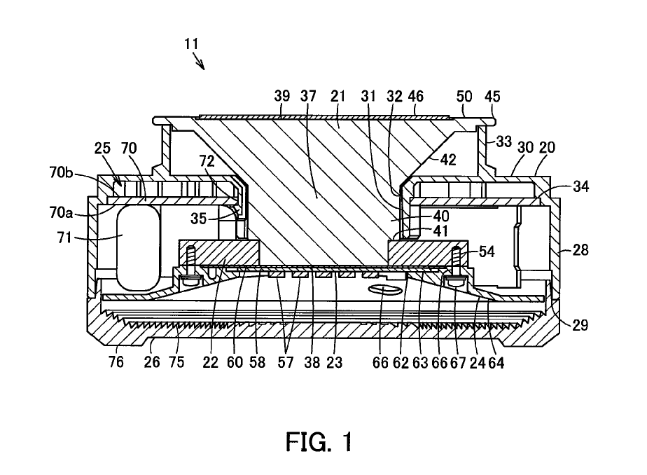

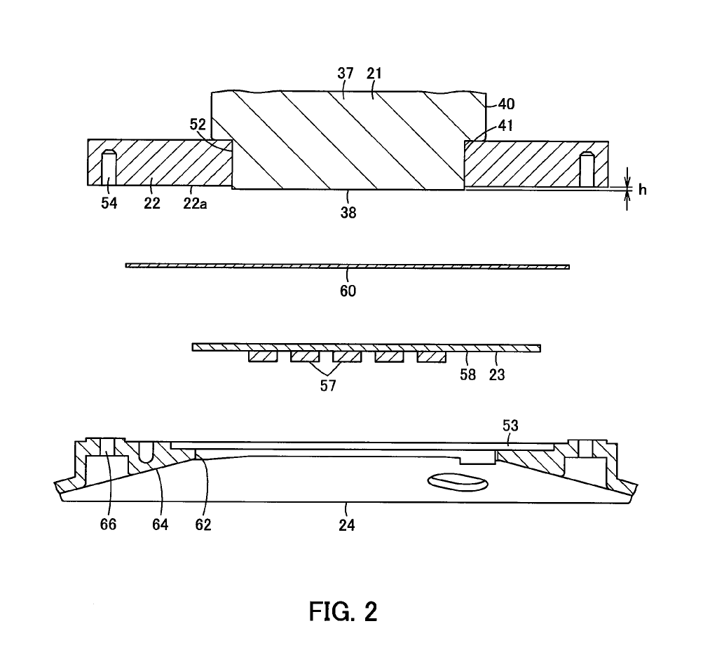

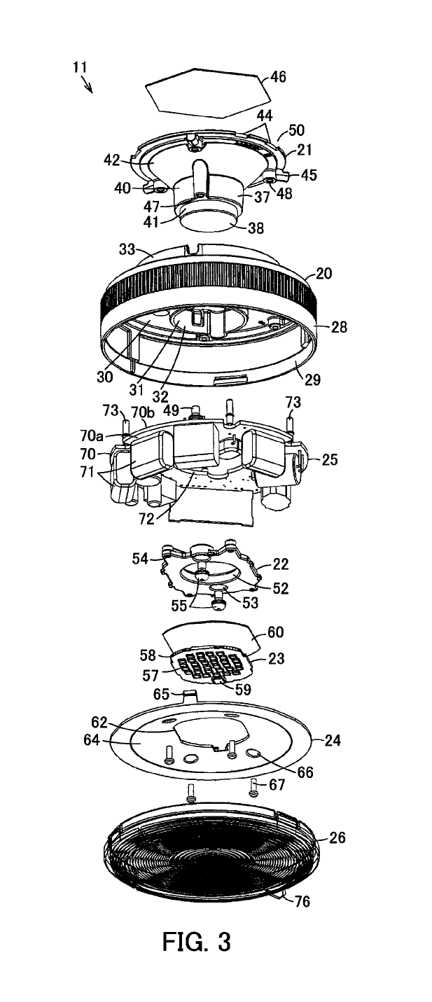

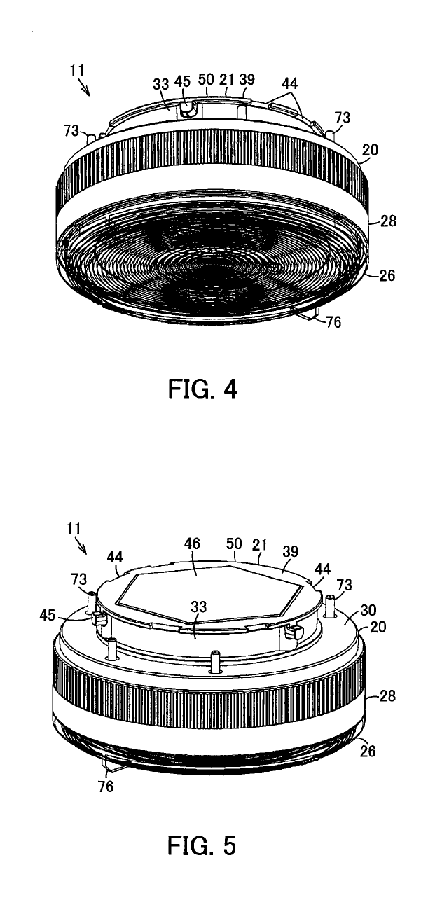

Hereinafter, an embodiment will be described with reference to FIG. 1 to FIG. 6.

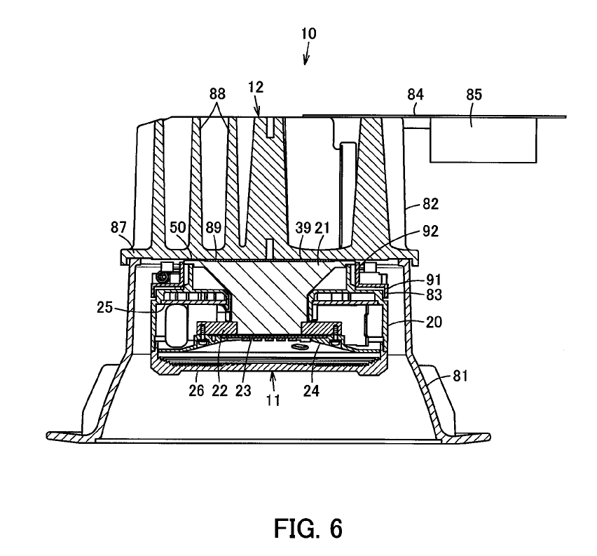

As shown in FIG. 6, a luminaire 10 is an embedded-type luminaire such as a downlight. The luminaire 10 includes a flat lamp device 11, and an equipment device 12 on which the lamp device 11 is detachably and attachably mounted.

As shown in FIG. 1 to FIG. 5, the lamp device 11 includes a housing 20, a thermal radiator 21, an attachment base 22, a light-emitting module 23, a reflector 24, a lighting device 25 and a translucent cover 26. Incidentally, in the following description, one end side of the lamp device 11, which is a light irradiation side, is a lower side, and the other end side thereof, which is an opposite side to the light irradiation direction, is an upper side.

The housing 20 is formed of an insulating material, such as synthetic resin, into a cylindrical shape, and includes a peripheral part 28, an opening part 29 at the lower side of the peripheral part 28, and a closed part 30 at the upper side of the peripheral part 28. A cylindrical insertion part 32 forming an insertion port 31 opened in an up-and-down direction is protrudingly provided at the center of the closing part 30 in the housing 20. An annular protrusion 33 to which the thermal radiator 21 is attached is upward protrudingly provided between the peripheral part of the closing part 30 and the insertion part 32. A circuit board placing part 34 on which the lighting device 25 (circuit board 70) is positioned and placed is formed inside the housing 20 and at the peripheral part of the closing part 30 and the outer peripheral part of the insertion part 32. Further, a locking part 35 to lock the lighting device 25 (the circuit board 70) is provided between the outer peripheral part of the insertion part 32 and the circuit board placing part 34.

Besides, the thermal radiator 21 is integrally formed of a metal material such as aluminum die cast. The thermal radiator 21 includes a cylindrical support part 37, a light-emitting module connection part 38 formed at the lower side of the support part 37, and an external thermal radiation part 39 formed at the upper side of the support part 37.

A columnar part 40 insertable into the insertion part 32 is formed at the lower side of the support part 37, and a step part 41 is formed around the lower periphery of the columnar part 40. A taper part 42 whose sectional area increases toward the upper external thermal radiation part 39 is formed at the upper side of the support part 37. An inclination angle of the taper part 42 is set to, for example, 45°.

The light-emitting module connection part 38 is a circular contact surface formed to be flat on the tip surface of the support part 37, and an area thereof is smaller than a sectional area of the support part 37 and is smaller than an area of the external thermal radiation part 39.

The external thermal radiation part 39 is formed into a disk shape larger than the support part 37 and the light-emitting module connection part 38, and is arranged on the protrusion 33 in a state where the peripheral part protrudes from the protrusion 33 in an outer diameter direction. A plurality of key grooves 44 and a plurality of keys 45 are disposed at specified positions on the peripheral part of the external thermal radiation part 39. A thermal conductive sheet 46 is attached to the upper surface of the external thermal radiation part 39.

A plurality of bosses 47 for screwing the attachment base 22 is provided around the support part 37, and a plurality of bosses 48 for screwing to the housing 20 is provided on the peripheral part of the external connection part 39. A plurality of screws 49 is screwed to the plurality of bosses 48 of the thermal radiator 21 from the inside of the housing 20, so that the housing 20 and the thermal radiator 21 are fixed.

A cap part 50 having a specified standard size is constructed of the upper side including the protrusion 33 of the housing 20, the external thermal radiation part 39 of the thermal radiator 21 and the like.

The attachment base 22 is made of an insulating material such as synthetic resin. A hole part 52 through which the light-emitting module connection part 38 is inserted is formed at the center of the attachment base 22. A plurality of attachment holes 53 for screwing to the thermal radiator 21 is formed in the peripheral part of the attachment base 22, and a plurality of attachment holes 54 for screwing the reflector 24 is formed. In a state where the light-emitting module connection part 38 is inserted through the hole part 52, and the attachment base 22 is arranged around the light-emitting module connection part 38, a plurality of screws 55 is screwed to the plurality of bosses 47 of the thermal radiator 21 from the attachment holes 53, so that the attachment base is fixed to the thermal radiator 21. In the state where the attachment base 22 is fixed to the thermal radiator 21, the light-emitting module connection part 38 protrudes from an attachment surface 22a of the attachment base 22. A protrusion amount h of the light-emitting module connection part 38 from the attachment surface 22a of the attachment base 22 is small, and is preferably smaller than, for example, the thickness of a board 58 of the light-emitting module 23.

The light-emitting module 23 includes a plurality of light-emitting elements 57, and the board 58 on which the plurality of light-emitting elements 57 are mounted.

For example, an SMD (Surface Mount Device) package is used for the light-emitting elements 57. The light-emitting elements 57 are closely arranged on the board 58 in an arbitrary arrangement. Incidentally, a COB (Chip On Board) system in which a plurality of LED chips is mounted on the board 58 and is integrally sealed with sealing resin containing phosphor may be used for the light-emitting elements 57, or another semiconductor light-emitting element such as an EL element may be used.

The board 58 is made of a material such as, for example, metal, ceramic or resin having excellent thermal conductivity. A pattern for electrically connecting the light-emitting elements 57 is formed on the mount surface of the board 58 on which the light-emitting elements 57 are mounted. A connector 59 for electrically connecting the lighting device 25 is mounted on the pattern of the board 58.

The back side of the board 58 of the light-emitting module 23 is arranged to contact the light-emitting module connection part 38 and the attachment base 22 through an insulating sheet which is also a heat conductive sheet. The plural light-emitting elements 57 are arranged in a region of the light-emitting module connection part 38 when viewed from below.

The insulating sheet 60 has heat conductivity and insulation properties as well as elasticity, and is formed to be larger than the light-emitting module connection part 38 and the board 58. When the insulating sheet 60 is sandwiched between the light-emitting module connection part 38 and the board 58 and between the attachment base 22 and the board 58, a step difference between the light-emitting module connection part 38 and the attachment base 22 is absorbed by a difference in compression amount of the insulating sheet 60, and the application of stress to the light-emitting module 23 is relieved.

The reflector 24 is made of an insulating material such as synthetic resin. A window hole 62 which is smaller than the outer shape of the board 58 and through which the light-emitting elements 57 can be inserted is formed at the center of the reflector 24. A recessed positioning part 63 in which the board 58 is fitted to be positioned is formed on the upper surface of the reflector 24. A reflecting surface 64 expanding downward from the peripheral edge part of the window hole 62 to the peripheral part of the reflector 24 is formed. A plurality of support pieces 65 supported by the housing 20 is provided at the peripheral part of the reflector 24. A plurality of attachment holes 66 for screwing the reflector 24 to the attachment base 22 is formed in the reflecting surface 64.

Screws 67 inserted through the attachment holes 66 are screwed and fastened to the attachment holes 54 of the attachment base 22, so that the board 58 is held in the state where the board is pressed to the light-emitting module connection part 38. At this time, the insulating sheet 60 sandwiched between the light-emitting module connection part 38 and the board 58 and between the attachment base 22 and the board 58 is compressed. Thus, the step difference between the light-emitting module connection part 38 and the attachment base 22 is absorbed by the difference in compression amount of the insulating sheet 60, and the application of stress to the light-emitting module 23 is relieved. The reflector 24 is arranged between the opening part 29 of the housing 20 and the light-emitting module 23, and covers the lighting device 25 so that light of the light-emitting elements 57 is not irradiated to the lighting device 25.

The lighting device 25 includes, for example, a power supply circuit to rectify and smooth commercial AC power and to convert into DC power, a DC/DC converter to supply the DC power as specified DC output to the LED elements by switching of a switching element and to light the LED elements, and a control IC to control the oscillation of the switching element. In the case of the dimming lighting device 25, a function is provided in which a current of the light-emitting element 57 is detected and is compared with a reference value corresponding to a dimming signal, and the control IC controls the switching operation of the switching element.

The lighting device 25 includes the circuit board 70 and circuit parts 71 as a plurality of electronic parts mounted on the circuit board 70.

The circuit board 70 is formed into an annular shape, and a circular fitting hole 72 through which the insertion part 32 of the housing 20 is inserted is formed at the center of the circuit board 70. A lower surface of the circuit board 70 is a mount surface 70a on which a lead part having a lead wire among the circuit parts 71 is mounted. An upper surface thereof is a wiring surface 70b as a wiring pattern surface or a solder surface provided with a wiring pattern to which the lead wire of the lead part is connected by soldering and on which a surface mount part among the circuit parts 71 is mounted.

The circuit board 70 is arranged at the upper position in the housing 20 in a state where the wiring surface 70b is directed upward and faces the closing part 30 of the housing 20. The circuit parts 71 mounted on the mount surface 70a of the circuit board 70 is arranged among the peripheral part 28 of the housing 20, the insertion part 32, the attachment base 22 and the reflector 24.

A power input side of the circuit board 70 is electrically connected to a pair of lamp pins 73 for power supply, and a lighting output side is electrically connected to the light-emitting module 23. The pair of lamp pins 73 for power supply protrudes vertically from the closing part 30 of the housing 20. Incidentally, in the case of the dimming lighting device 25, in addition to the lamp pins for power supply, a plurality of lamp pins 73 for dimming also protrudes vertically from the closing part 30 of the housing 20.

The translucent cover 26 is formed into a disk shape from a synthetic resin having translucency, and is attached to the housing 20 so as to cover the opening part 29. A Fresnel lens 75 for controlling the light emitted from the lamp device 11 to obtain a specified luminous intensity distribution is formed on the inner surface (upper surface) of the translucent cover 26 facing the light-emitting module 23. The Fresnel lens 75 has a saw-like sectional shape in the diameter direction and is formed concentrically. A finger hook part 76 to facilitate the rotation operation of the lamp device 11 attached to and detached from the equipment device 12 (socket) is protrudingly provided at the lower surface peripheral part of the translucent cover 26. Incidentally, the Fresnel lens 75 may not be provided on the inner surface of the translucent cover 26, and a diffusion surface to diffuse light may be provided.

Next, as shown in FIG. 6, the equipment device 12 includes an equipment reflector 81 expanded and opened downward, an equipment thermal radiator 82 as an equipment body attached to an upper part of the equipment reflector 81, a socket 83 attached to a lower part of the equipment thermal radiator 82, a terminal base 85 attached to an upper part of the equipment thermal radiator 82 by an attachment plate 84, and a plurality of attachment springs for ceiling attachment attached to the periphery of the equipment thermal radiator 82.

The equipment reflector 81 is formed into a cylindrical shape expanding downward.

The equipment thermal radiator 82 is made of a material, for example, metal such as aluminum die cast, ceramic, or resin having excellent thermal radiation properties. The equipment thermal radiator 82 includes a disk-shaped base part 87, and a plurality of thermal radiation fins 88 protruding from an upper surface of the base part 87. A flat contact surface 89 exposed in the equipment reflector 81 is formed on a lower surface of the base part 87.

The socket 83 includes a socket body 91 formed into an annular shape from an insulating synthetic resin, and a not-shown pair of terminals for power supply arranged in the socket body 91. Incidentally, when dimming is supported, a plurality of terminals for dimming is also provided.

A circular insertion hole 92 through which the cap part 50 (protrusion 33) of the lamp device 11 is inserted is formed at the center of the socket body 91. A plurality of connection holes through which the lamp pins 73 of the lamp device 11 are inserted is formed into a long hole shape along the circumferential direction on a lower surface of the socket body 91. Terminals are arranged on upper sides of the respective connection holes, and the lamp pins 73 of the lamp device 11 inserted in the connection holes are electrically connected to the terminals.

A plurality of keys is protrudingly formed on the inner peripheral surface of the socket body 91, and a plurality of substantially L-shaped key grooves is formed. The keys and the key grooves of the socket 83 and the key grooves 44 and the keys 45 of the lamp device 11 are respectively provided at corresponding positions. The keys 45 and the key grooves 44 of the lamp device 11 are matched with the key grooves and the keys of the socket 83, the cap part 50 of the lamp device 11 is inserted in the socket 83, and the lamp device 11 is rotated, so that the lamp device 11 can be detachably and attachably mounted on the socket 83.

The socket 83 is supported to the equipment thermal radiator 82 by a support mechanism. In the support mechanism, the cap part 50 of the lamp device 11 is mounted on the socket 83, so that the upper surface of the cap part 50, that is, the external thermal radiation part 39 of the thermal radiator 21 is pressed to the contact surface 89 of the equipment thermal radiator 82 and the thermal conductivity is improved.

The attachment base 85 is electrically connected to the terminal of the socket 83.

In the luminaire 10 including the lamp device 11 and the equipment device 12 as stated above, in order to mount the lamp device 11 on the equipment device 12, the keys 45 and the key grooves 44 of the cap part 50 are matched with the key grooves and the key of the socket 83, the cap part 50 is inserted in the socket 83, and the lamp device 11 is rotated by a specified angle with respect to the socket 83. As a result, the keys 45 of the cap part 50 are locked by the key grooves of the socket 83, and the lamp device 11 can be attached to the socket 83. By this, the lamp pins 73 of the cap part 50 are electrically connected to the respective terminals of the socket 83. Besides, the upper surface of the cap part 50, that is, the external thermal radiation part 39 of the thermal radiator 21 is pressed to and in close contact with the contact surface 89 of the equipment thermal radiator 82 through the thermal conductive sheet 46, and heat can be efficiently conducted from the thermal radiator 21 to the equipment thermal radiator 82.

At the time of lighting of the lamp device 11, commercial AC power is supplied to the lighting device 25 of the lamp device 11. The lighting device 25 converts the commercial AC power into specified DC power and supplies the power to the light-emitting elements 57 of the light-emitting module 23, so that the light-emitting elements 57 are lit. The light of the lit light-emitting elements 57 passes through the translucent cover 26 and is irradiated to a specified irradiation direction.

In the lamp device 11, since the light-emitting module 23 is arranged at the position close to the translucent cover 26 by the thermal radiator 21, most of the light of the light-emitting elements 57 is directly incident on the translucent cover 26 and is emitted, so that the light extraction efficiency can be improved.

Besides, at the time of lighting of the lamp device 11, heat generated by the light-emitting elements 57 of the light-emitting module 23 is mainly conducted from the board 58 to the light-emitting module connection part 38 of the thermal radiator 21, the support part 37 and the external thermal radiation part 39 through the insulating sheet 60. Further, the heat is conducted from the external thermal radiation part 39 to the equipment thermal radiator 82 through the heat conductive sheet 46, and is radiated to the air from the plurality of thermal radiation fins 88 of the equipment thermal radiator 82.

At this time, since the light-emitting module connection part 38 protrudes from the attachment surface 22a of the attachment base 22 to which the light-emitting module 23 is attached, the board 58 of the light-emitting module 23 certainly contacts the light-emitting module connection part 38, and the heat generated by the light-emitting elements 57 is efficiently conducted from the board 58 to the light-emitting module connection part 38.

Further, since the support part 37 of the thermal radiator 21, the light-emitting module connection part 38 and the external thermal radiation part 39 are integrally formed, the heat generated by the light-emitting elements 57 is efficiently conducted from the light-emitting module connection part 38 of the thermal radiator 21 to the external thermal radiation part 39.

In general, heat has a characteristic of being radially conducted. Since the sectional area of the support part 37 is increased from the light-emitting module connection part 38 toward the external thermal radiation part 39, heat conduction loss at the support part 37 can be reduced. Thus, the heat generated by the light-emitting elements 57 of the light-emitting module 23 can be efficiently conducted from the light-emitting module connection part 38 to the external thermal radiation part 39.

Accordingly, the heat generated by the light-emitting elements 57 can be efficiently conducted to the thermal radiator 21, and the thermal radiation properties from the external thermal radiation part 39 of the thermal radiator 21 can be improved.

Besides, at the time of lighting of the lamp device 11, the heat generated by the lamp device 25 is conducted to the housing 20 and the like, and is radiated to the air from the surface of the housing 20 and the like.

In the lamp device 11 of this embodiment, since the insulating attachment base 22 is arranged around the light-emitting module connection part 38 of the thermal radiator 21, the peripheral part of the light-emitting module 23 connected to the light-emitting module connection part 38 can be stably supported, and insulation properties against the lighting device 25 can be secured. Further, since the light-emitting module connection part 38 protrudes from the attachment surface 22a of the attachment base 22, the light-emitting module 23 certainly contacts the light-emitting module connection part 38, and excellent thermal radiation properties can be secured.

Further, since the attachment base 22 is formed of insulating material, the attachment base 22 and the circuit parts 71 of the lighting device 25 can be arranged to be close to each other, and the lamp device 11 can be miniaturized.

Besides, the insulating sheet 60 intervenes between the light-emitting module connection part 38 and the light-emitting module 23 and between the attachment base 22 and the light-emitting module 23. Thus, the step difference between the light-emitting module connection part 38 and the attachment base 22 is absorbed by the difference in compression amount of the insulating sheet 60, and the application of stress to the light-emitting module 23 can be relieved.

Besides, since the reflector 24 is arranged between the opening part 29 of the housing 20 and the light-emitting module 23, the reflector 24 reflects the light of the light-emitting elements 57 to the irradiation direction, and the light extraction efficiency can be improved. Further, since the reflector 24 covers the lighting device 25, the light of the light-emitting elements 57 can be prevented from being irradiated to the circuit board 70 of the lighting device 25 and the circuit parts 71, and light deterioration of the circuit board 70 and the circuit parts 71 can be prevented. Further, the board 58 can be held between the reflector 24 and the attachment base 22. Accordingly, the reflector 24 has the three functions, that is, the reflection function, the protection function of the lighting device 25 and the fixing function of the light-emitting module 23.

Incidentally, since the attachment base 22 is made of the insulating material having excellent heat conductivity, the heat generated by the light-emitting elements 57 can be efficiently conducted from the board 58 to the thermal radiator 21 through the attachment base 22, and the thermal radiation properties can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lamp device comprising:
a housing including an opening part at one end side, a closing part at the other end side and an insertion part formed at a center of the closing part;
a light-emitting module arranged in the housing so as to emit light from the opening part;
a lighting device arranged to be closer to the closing part side than the light-emitting module in the housing and including a circuit board arranged around the insertion part;
a thermal radiator including a support part inserted through the insertion part, a light-emitting module connection part which is provided at one end side of the support part and to which the light-emitting module is thermally conductively connected, and a thermal radiator provided at the other end side of the support part and including an external thermal radiation part; and
an attachment base which is made of an insulating material, is arranged around the light-emitting module connection part, is provided with an attachment surface facing the light-emitting module at one end side, and supports the light-emitting module connected to the light-emitting module connection part which protrudes from the attachment surface.

2. The device according to claim 1, further comprising an insulating sheet intervening between the light-emitting module connection part and the light-emitting module and between the attachment base and the light-emitting module.

3. The device according to claim 1, further comprising a reflector which is arranged between the opening part of the housing and the light-emitting module, and holds the light-emitting module between itself and the attachment base.

4. The device according to claim 3, wherein the reflector covers the lighting device.

5. The device according to claim 1, wherein the light-emitting module includes a plurality of light-emitting elements and a board on which the plurality of light-emitting elements is mounted, the board is larger than the light-emitting module connection part, and the plurality of light-emitting elements is arranged in a region facing the light-emitting module connection part.

6. The device according to claim 5, wherein a protrusion amount of the light-emitting module connection part protruding from the attachment base is smaller than a thickness of the board.

7. The device according to claim 1, wherein a sectional area of the support part increases from the light-emitting module connection part toward the external thermal radiation part.

8. The device according to claim 1, wherein the support part includes a columnar part which is formed at the one end side of the support part and is inserted through the insertion part, and a taper part which is formed at the other end side of the support part and whose sectional area increases toward the external thermal radiation part at an outside of the closing part.

9. The device according to claim 1, wherein a hole part through which the light-emitting module connection part is inserted is formed at a center of the attachment base, and a step part in which the attachment base is fitted is formed on a periphery of the support part at the one end side.

10. A luminaire comprising:
a lamp device including
a housing including an opening part at one end side, a closing part at the other end side and an insertion part formed at a center of the closing part,
a light-emitting module arranged in the housing so as to emit light from the opening part,
a lighting device arranged to be closer to the closing part side than the light-emitting module in the housing and including a circuit board arranged around the insertion part,
a thermal radiator including a support part inserted through the insertion part, a light-emitting module connection part which is provided at one end side of the support part and to which the light-emitting module is thermally conductively connected, and a thermal radiator provided at the other end side of the support part and including an external thermal radiation part, and
an attachment base which is made of an insulating material, is arranged around the light-emitting module connection part, is provided with an attachment surface facing the light-emitting module at one end side, and supports the light-emitting module connected to the light-emitting module connection part which protrudes from the attachment surface; and
an equipment device including a socket to which the lamp device is connected.

11. The luminaire according to claim 10, wherein the lamp device includes an insulating sheet intervening between the light-emitting module connection part and the light-emitting module and between the attachment base and the light-emitting module.

12. The luminaire according to claim 10, wherein the lamp device includes a reflector which is arranged between the opening part of the housing and the light-emitting module, and holds the light-emitting module between itself and the attachment base.

13. The luminaire according to claim 12, wherein the reflector covers the lighting device.

14. The luminaire according to claim 10, wherein the light-emitting module includes a plurality of light-emitting elements and a board on which the plurality of light-emitting elements is mounted, the board is larger than the light-emitting module connection part, and the plurality of light-emitting elements is arranged in a region facing the light-emitting module connection part.

15. The luminaire according to claim 14, wherein a protrusion amount of the light-emitting module connection part protruding from the attachment base is smaller than a thickness of the board.

16. The luminaire according to claim 10, wherein a sectional area of the support part increases from the light-emitting module connection part toward the external thermal radiation part.

17. The luminaire according to claim 10, wherein the support part includes a columnar part which is formed at the one end side of the support part and is inserted through the insertion part, and a taper part which is formed at the other end side of the support part and whose sectional area increases toward the external thermal radiation part at an outside of the closing part.

18. The luminaire according to claim 10, wherein a hole part through which the light-emitting module connection part is inserted is formed at a center of the attachment base, and a step part in which the attachment base is fitted is formed on a periphery of the support part at the one end side.
